(19) United States
(12) Patent Application Publication
(10) Pub. No.: US 2018/0274272 A1
(43) Pub. Date: Sep. 27, 2018

(54) VEHICULAR CLOSURE LATCH ASSEMBLY WITH ANTI-CHUCKING LATCH MECHANISM

(71) Applicant: Magna Closures Inc., Newmarket (CA)

(72) Inventors: Kar Wang WOO, Markham (CA); Neil GUILLERMO, Richmond Hill (CA); Amarinder SINGH, Brampton (CA)

(21) Appl. No.: 15/919,565

(22) Filed: Mar. 13, 2018

Related U.S. Application Data
(60) Provisional application No. 62/474,796, filed on Mar. 22, 2017.

(51) Int. Cl. E05B 85/26; E05B 77/46; E05B 83/36; E05B 85/24; E05B 79/04; E05B 77/36

(52) U.S. Cl. CPC E05B 85/26; E05B 77/46; E05B 83/36; E05Y 2900/531; E05B 79/04; E05B 77/36; E05Y 2600/46; E05B 85/243

(57) ABSTRACT

A closure latch assembly for a dual-door closure system in a motor vehicle and configured to provide an anti-chucking mechanism in cooperation with a latch mechanism. The anti-chucking mechanism cooperates with the latch mechanism to provide an anti-chucking feature.

### CROSS-REFERENCE TO RELATED APPLICATIONS

This application claims the benefit of U.S. provisional application No. 62/474,796, filed on Mar. 22, 2017. The entire disclosure of the above application is incorporated herein by reference.

### FIELD

The present disclosure relates generally to door closure systems for motor vehicles. More specifically, the present disclosure relates to a vehicular closure latch assembly equipped with an anti-chucking type of latch mechanism.

### BACKGROUND

This section provides background information related to vehicular door closure systems and is not necessarily prior art to the inventive concepts associated with the present disclosure.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit movement of the door to its open position. The latch assembly is also equipped with a latch release mechanism that is selectively actuated (manually via a handle-actuated release system and/or via a power-operated release system) to shift the latch mechanism into its unlatched mode.

Many vehicles are equipped with multiple side (i.e., front and rear), doors for access to the passenger compartment. Most commonly, when viewed from the front of the vehicle, the front and rear side doors are hinged proximate their front edge. The front doors are hinged to a front structural pillar (i.e., the A-pillar), while the rear doors are hinged to an intermediate structural pillar (i.e., the B-pillar), which is situated between the front and rear doors. The latch assemblies associated with the front doors are arranged to latch with a front striker fixed to the B-pillar. Likewise, the latch assemblies associated with the rear doors are arranged to latch with a rear striker fixed to a rearward sill portion of the opening. In some vehicles, such as pick-up trucks with extended cabs, the vehicle body is formed with an enlarged door opening without a structural B-pillar. Such “pillar-less” dual-door closure systems typically include a front swing door pivotably hinged along its front edge to the front vertical structural portion (i.e., the A-pillar), of the door opening and a rear swing door pivotably hinged along its rear edge to a rear vertical structural portion (i.e., the C-pillar), of the door opening. The absence of the intermediate structural pillar (i.e., the B-pillar), requires that the rear door must latch along at least one of upper and lower portions of the enlarged access opening while the front door must latch directly to the rear door. Typically, the latch assembly in the rear door cannot be unlatched until the front door latch assembly has been released and the front door swung to its open position.

A great deal of development has been directed to latching systems for such dual-door pillar-less closure arrangements. One recognized issue requiring corrective action is the elimination of door rattle or “chucking” noise that is generated at the latched interface between the front and rear doors during motive operation of the motor vehicle. Most commonly, this chucking noise is generated due to movement between the ratchet associated with the latch mechanism in the door latch assembly and the door-mounted striker. One known anti-chucking solution has employed a rubber bumper mounted to the striker to eliminate the chucking movement of the striker relative to the ratchet via a “wedging” function. However, high release effort, as well as high latching effort, are required to overcome this resilient wedging function.

Accordingly, a recognized need exists to address and overcome this known drawback by providing an anti-chucking solution in association with the latch assembly.

### SUMMARY

This section provides a general summary of the present disclosure and is not intended to be considered a comprehensive and exhaustive listing of its full scope or all aspects, objectives and features.

It is an aspect of the present disclosure to provide a closure latch assembly for a vehicular door closure system having an anti-chucking function.

It is a related aspect of the present disclosure to provide the closure latch assembly having the anti-chucking function for use in a dual-door vehicular closure system.

It is another related aspect of the present disclosure to provide the closure latch assembly with a latch mechanism and an anti-chucking mechanism arranged to work cooperatively to provide the anti-chucking function.

In accordance with these and other aspects, the present disclosure provides a closure latch assembly comprised of a latch mechanism, an anti-chucking mechanism, and a latch release mechanism. The latch mechanism includes a ratchet, a ratchet spring, a pawl, and a pawl biasing spring. The ratchet is pivotably moveable between a striker release position, a striker capture position, and a striker over-travel position. The ratchet spring biases the ratchet toward its striker release position. The pawl is pivotably moveable between a ratchet holding position for holding the ratchet in its striker capture position and a ratchet releasing position for permitting the ratchet spring to forcibly pivot the ratchet to its striker release position. The pawl spring biases the pawl toward its ratchet holding position. The latch release mechanism includes a release lever and a release lever spring. The release lever is pivotably moveable between a non-actuated position for permitting the pawl to remain in its ratchet holding position and an actuated position for moving the pawl to its ratchet releasing position. The release lever spring biases the release lever toward its non-actuated position. The anti-chucking mechanism includes an anti-chuck lever and an anti-chuck lever spring. The anti-chuck lever is moveable between a released position whereat the anti-chuck lever is disengaged from the ratchet and an engaged position whereat the anti-chuck lever establishes an engagement interface with the ratchet. The anti-chuck lever spring biases the anti-chuck lever toward its engaged position. Movement of the pawl from its ratchet holding position to its ratchet releasing position in response to actuation of the latch release mechanism causes corresponding movement of the anti-chuck lever from its engaged position to its released position. Upon movement of the ratchet from its striker over-travel position into its striker capture position, the pawl moves into its ratchet holding position and the anti-chuck lever moves into its engaged position. As such, the pawl inhibits movement of the ratchet in a first or “push-out” direction while the engagement interface between the anti-chuck lever and the ratchet inhibits movement of the ratchet in a second or “push-in” direction so as to securely retain the striker within the ratchet and provide an anti-chucking function.

The closure latch assembly of the present disclosure is configured such that the pawl is pivotably supported by a pawl rivet for movement between its ratchet holding and ratchet releasing positions and the anti-chuck lever is pivotably supported by the pawl rivet for movement between its released and engaged positions.

The closure latch assembly of the present disclosure is also configured such that a leg segment of the pawl is selectively engageable with a lever lug segment of the anti-chuck lever for holding the anti-chuck lever in its released position when the pawl is located in its ratchet releasing position.

The closure latch assembly of the present disclosure is also configured such that the anti-chuck lever spring moves the anti-chuck lever from its released position toward its engaged position until an edge segment of the anti-chuck lever engages a stop lug formed on the ratchet.

The closure latch assembly of the present disclosure is also configured such that the stop lug on the ratchet is retained in a latch shoulder formed in an end segment of the anti-chuck lever when the anti-chuck lever is located in its engaged position to define the engagement interface between the ratchet and the anti-chuck lever.

The closure latch assembly of the present disclosure is also configured such that the pawl and the anti-chuck lever cooperate to retain the striker in the striker retention seat when the ratchet is located in its striker capture position.

The closure latch assembly of the present disclosure may also establish the engagement interface between the ratchet and the anti-chuck lever via a latch lug on the anti-chuck lever being seated in a latch aperture formed in the ratchet.

In accordance with these and other aspects, the present disclosure provides a closure latch assembly for a motor vehicle closure system having a door moveable between open and closed positions. The closure latch assembly comprises: a latch mechanism having a ratchet moveable between a striker release position, a striker capture position, and a striker over-travel position, a ratchet spring biasing the ratchet toward its striker release position, a pawl moveable between a ratchet holding position for holding the ratchet in its striker capture position and a ratchet releasing position for permitting the ratchet to move to its striker release position, and a pawl spring for biasing the pawl toward its ratchet holding position; a latch release mechanism operable for moving the pawl from its ratchet holding position into its ratchet releasing position; and an anti-chucking mechanism having an anti-chuck lever moveable between a released position and an engaged position, and an anti-chuck lever spring for biasing the anti-chuck lever toward its engaged position, wherein the pawl is operable in its ratchet holding position to inhibit movement of the ratchet in a releasing direction from its striker capture position toward its striker release position, and wherein the anti-chuck lever is operable in its engaged position to engage the ratchet and inhibit movement of the ratchet in a closing direction from its striker capture position toward its striker over-travel position.

The closure latch assembly of the present disclosure is also configured such that movement of the pawl from its ratchet holding position to its ratchet releasing position in response to actuation of the latch release mechanism causes corresponding movement of the anti-chuck lever from its engaged position to its released position.

The closure latch assembly of the present disclosure is also configured such that movement of the door from its open position to its closed position causes a striker to engage the ratchet and forcibly move the ratchet in the closing direction from its striker release position to its striker over-travel position. Movement of the ratchet into its striker over-travel position permits the pawl to move from its ratchet releasing position into its ratchet holding position, and movement of the pawl to its ratchet holding position permits the anti-chuck lever spring to move the anti-chuck lever from its released position into its engaged position.

The closure latch assembly of the present disclosure is also configured such that an engagement interface is established between the ratchet and the anti-chuck lever when the anti-chuck lever is located in its engaged position. The engagement interface inhibits movement of the ratchet in the closing direction from its striker capture position to its striker over-travel position.

The closure latch assembly of the present disclosure can be configured such that the engagement interface is defined by a stop lug on the ratchet engaging a lever latch shoulder on the anti-chuck lever. Alternatively, the engagement interface can be defined by a lever latch lug formed on the anti-chuck lever that is retained within a latching notch formed in the ratchet.

The closure latch assembly of the present disclosure is further configured such that the ratchet spring forcibly moves the ratchet in the releasing direction from its striker over-travel position into its striker capture position whereat a pawl latch lug on the pawl engages a latch shoulder on the ratchet for holding the ratchet in its striker capture position when the pawl is located in its ratchet holding position so as to inhibit movement of the ratchet in the releasing direction. As noted, the engagement interface between the ratchet and the anti-chuck lever inhibits movement of the ratchet in its closing direction. As a result, engagement of the ratchet with both of the pawl and the anti-chuck lever in its striker capture position provides the anti-chucking feature.

The closure latch assembly of the present disclosure is configured such that the anti-chucking feature functions to retain the striker in a striker retention seat formed in the ratchet and to resist a striker push-out force acting in the releasing direction and a striker push-in force acting in the closing direction.

The closure latch assembly of the present disclosure is configured such that the striker is fixed to a rear door of a dual-door closure system and the closure latch assembly is fixed to a front door of the dual-door closure system.

In accordance with these and other aspects, the present disclosure provides a closure latch assembly for a motor vehicle having a door moveable between open and closed positions relative to a striker. The closure latch assembly comprises: a latch mechanism having a ratchet moveable between a striker release position when the door is in its open position, a striker capture position when the door is in its closed position, and a striker over-travel position, and a pawl moveable between a ratchet holding position whereat the pawl holds the ratchet in its striker capture position and a ratchet releasing position whereat the pawl permits the ratchet to move to is striker release position; and an anti-chucking mechanism having an anti-chuck lever moveable between a released position whereat the anti-chuck lever is disengaged from the ratchet and an engaged position whereat the anti-chuck lever establishes an engagement interface with the ratchet, wherein the pawl is operable in its ratchet holding position to inhibit movement of the ratchet in a ratchet releasing direction towards its striker release position, and wherein the anti-chuck lever is operable in its engaged position to inhibit movement of the ratchet in a ratchet closing direction toward its striker over-travel position, whereby the pawl and anti-chuck lever work cooperatively to retain the striker in a striker retention seat formed in the ratchet when the ratchet is located in its striker capture position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a motor vehicle equipped with a pillar-less dual-door closure system;

FIG. 2 is a side elevational view of the motor vehicle shown in FIG. 1 with the doors of the dual-door closure system located in a closed position;

FIG. 3 is a side isometric view of the motor vehicle shown in FIG. 1 with the doors of the dual-door closure system located in a partially open position;

FIG. 4 is an isometric view of a closure latch assembly for use with at least one of the doors of the dual-door closure system and which is configured to provide an anti-chucking function in accordance with the present disclosure;

FIGS. 5A and 5B are sectional views of the closure latch assembly shown in FIG. 4;

FIG. 6 is an exploded isometric view of the closure latch assembly shown in FIG. 4 illustrating a latch module, a latch cover, and a seal grommet associated therewith;

FIG. 7 is an exploded isometric view of the latch module shown in FIG. 6;

FIG. 8 is an assembled isometric view of the closure latch assembly of the present disclosure;

FIG. 9 is a sectional view of the closure latch assembly shown in FIG. 8;

FIG. 10 is the first in a series of sequential plan views of the closure latch assembly showing the operational orientation of a latch mechanism in an unlatched mode, a latch release mechanism in a non-actuated mode, and an anti-chucking mechanism in a released mode when the door is open;

FIG. 11 is the second in the series of sequential plan views of the closure latch assembly showing the operational orientation of the latch mechanism and the anti-chucking mechanism when the door is swung from its open position toward its fully closed position and a striker engages a ratchet of the latch mechanism;

FIG. 12 is the third in the series of sequential plan views of the closure latch assembly showing the ratchet held in a secondary striker capture position by a pawl located in a ratchet holding position for shifting the latch mechanism into a secondary latched mode while the anti-chucking mechanism is maintained in its released mode when the door is moved into a partially-closed position;

FIG. 13 is the fourth in the series of sequential plan views of the closure latch assembly showing the ratchet rotated by the striker to a striker over-travel position upon movement of the door into its fully closed position;

FIG. 14 is the fifth in the series of sequential plan views of the closure latch assembly showing the ratchet held by the pawl in a primary striker capture position so as to shift the latch mechanism into a primary latched mode while the anti-chucking mechanism begins to shift from its released mode into an engaged mode;

FIG. 15 is the sixth in the series of sequential plan views of the closure latch assembly showing the latch mechanism in its primary latched mode and the anti-chucking mechanism in its engaged mode for holding the door in its fully-closed position;

FIG. 16 is similar to FIG. 13 and illustrates the loading associated with attempted movement of the striker in both push-in and push-out directions relative to the latch mechanism when operating in its primary latched mode for providing the anti-chucking function;

FIG. 17 is an enlarged partial view of FIG. 16; and

FIGS. 18 and 19 illustrate an alternative embodiment for the engagement interface between the ratchet of the latch mechanism and the anti-chuck lever of the anti-chucking mechanism when the latch mechanism is in its primary latched mode and the anti-chucking mechanism is in its engaged mode.

Corresponding reference numerals indicate corresponding parts throughout the several views of the drawings.

### DETAILED DESCRIPTION

Example embodiments of a closure latch assembly configured to include a latch mechanism and an anti-chucking mechanism will now be more fully described with reference to the accompanying drawings. These example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

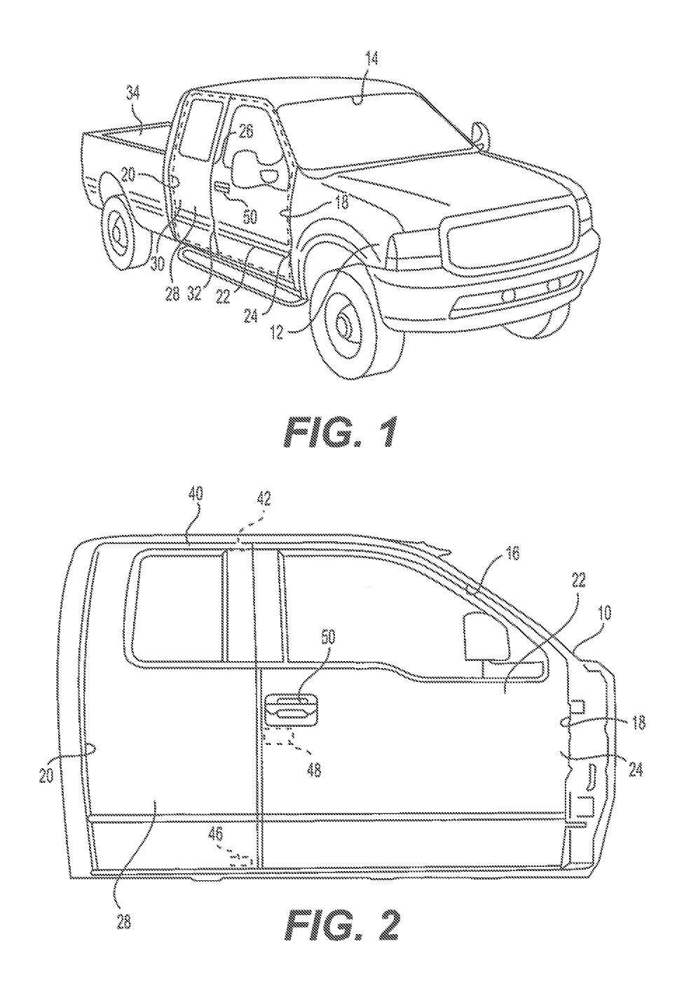

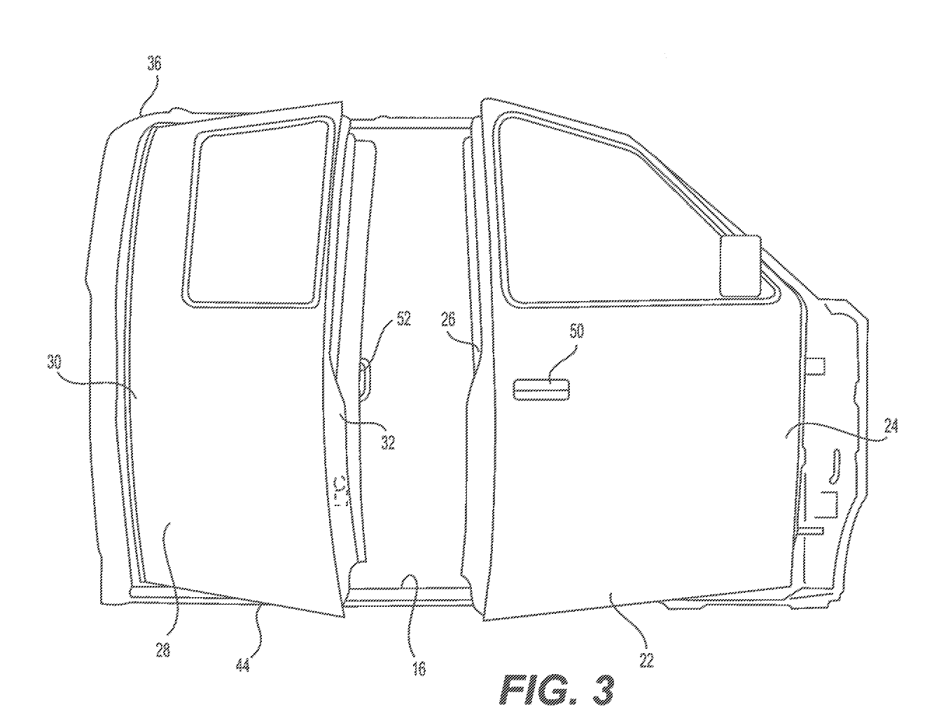

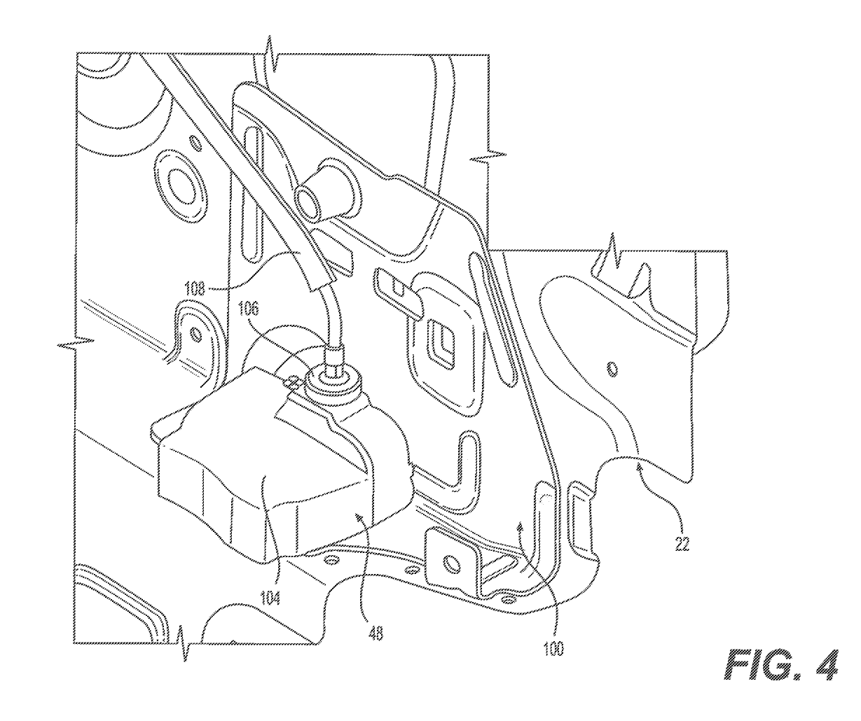

Referring initially to FIGS. 1-3, a motor vehicle is shown configured as a pickup truck including a vehicle body 10 having an exterior 12 and an interior 14 defining a passenger compartment. Connecting exterior 12 and interior 14 of vehicle body 10 is a continuous or “pillar-less” side opening 16 defining a first or front terminal end 18 and a second or rear terminal end 20. Providing a first moveable closure member for a front portion of opening 16 is a first or front door 22 having a forward portion 24 pivotably connected via front hinges (not shown) to vehicle body 10 adjacent to front terminal end 18 of opening 16. Front door 22 has a rearward portion 26 generally opposite its pivotal connection to vehicle body 10. Providing a second moveable closure member for a rear portion of opening 16 is a second or rear door 28. Rear door 28 has a rearward portion 30 which is pivotably connected via rear hinges (not shown) to vehicle body 10 adjacent to rear terminal end 20 of opening 16 and has a forward portion 32 generally opposite to its pivotal connection. When front door 22 and rear door 28 are closed together, the extreme end of rearward portion 26 of front door 22 overlaps and is latched to the extreme end of forward portion 32 of rear door 28. Accordingly, front door 22 and rear door 28 together define a dual-door closure arrangement.

Rear door 28 is schematically shown along its upper edge 40 to have a releasable latched connection via a first closure latch assembly 42 with vehicle body 10 at a location between front and rear terminal ends 18 and 20 of opening 16. Rear door 28 is also schematically shown along a bottom edge 44 to have a releasable latched connection via a second closure latch assembly 46 with vehicle body 10 at a location between front and rear terminal ends 18 and 20 of opening 16. When closed, front door 22 has a releasable latched connection via a third closure latch assembly 48 with rear door 28. Third closure latch assembly 48 is shifted from a latched mode into an unlatched mode via actuation of a latch release mechanism associated with a front door handle 50. The latch release mechanism may be manually-operated or power-operated to facilitate the release of third closure latch assembly 48. A release handle 52 is provided on an interior wall along forward portion 32 of rear door 28 and can be actuated, with front door 22 open, to concurrently shift each of first closure latch assembly 42 and second closure latch assembly 46 from its latched mode into its unlatched mode to permit rear door 28 to pivot outwardly toward its open position.

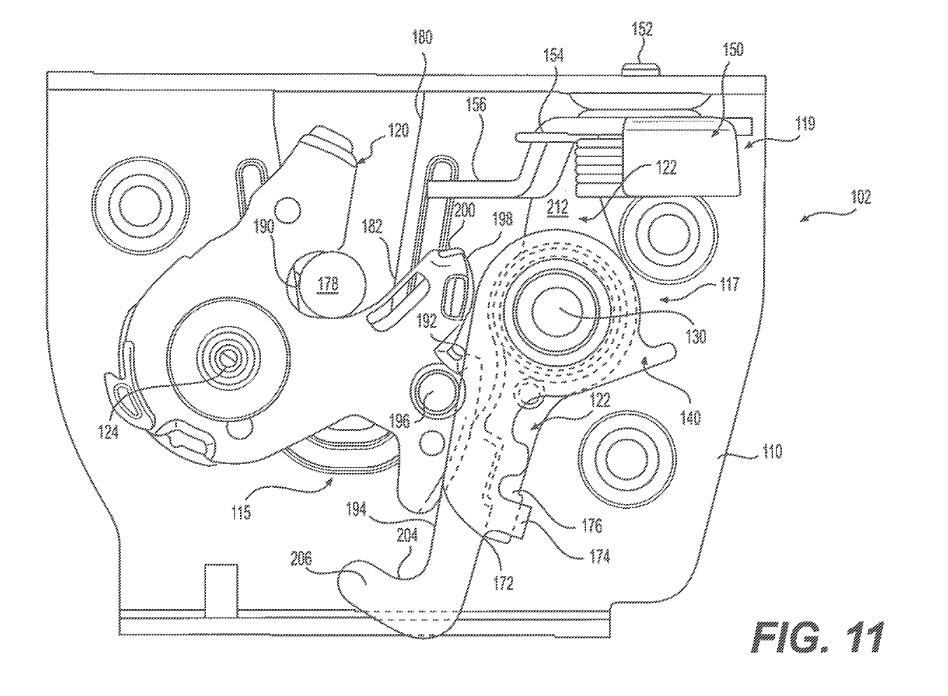

Those skilled in the art will recognize that the particular location of first and second closure latch assemblies 42, 46 and third closure latch assembly 48 shown in FIGS. 1-3 is merely intended to illustrate one exemplary dual-door latching arrangement and is not intended to limit the present disclosure. The closure latch assembly 48 described herein may also be employed in single door latching arrangements, where the closure latch assembly 48 is arranged on a vehicle door and operable to releaseably latch a striker fixed to the rearward sill of the vehicle body 10 or a pillar (e.g. B-pillar) adjacent to the door, as opposed to a striker 178 (FIG. 11) fixed to the edge portion of rear door 28 as illustrated in FIGS. 1-3. Further the closure latch assembly 48 may be employed in other automotive latching configurations, such as a hook latch, a side door latch, a cargo door latch, a decklid latch, a glass latch, a sliding door latch, an auxiliary latch, an emergency release latch, a seat latch, a liftgate latch, a tailgate latch, and the like. Likewise, the type of latch release mechanism employed is not relevant to the inventive concepts associated with the present disclosure and those skilled in the art will appreciate that any known power and/or manual latch release mechanism can be associated with each of the closure latch assemblies. Dual-door systems may also include sliding door systems, tailgate systems, access hatch systems, or other ingress/egress systems.

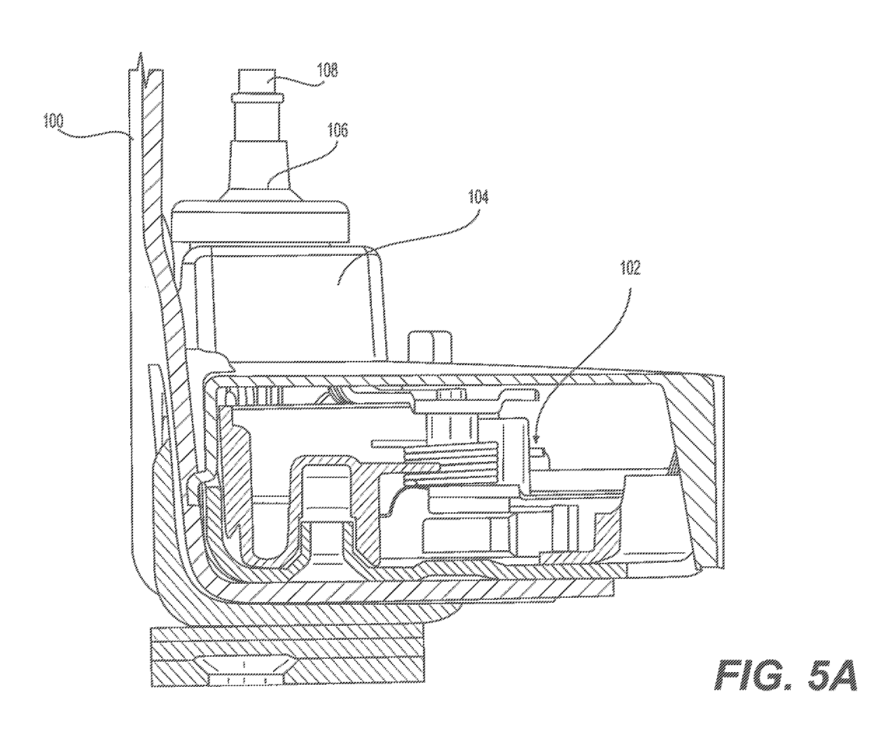

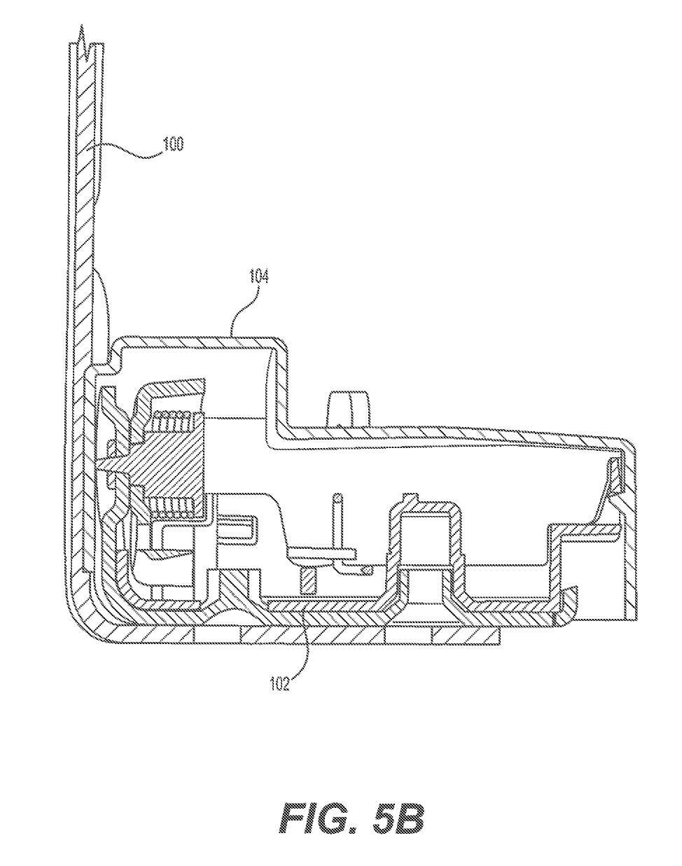

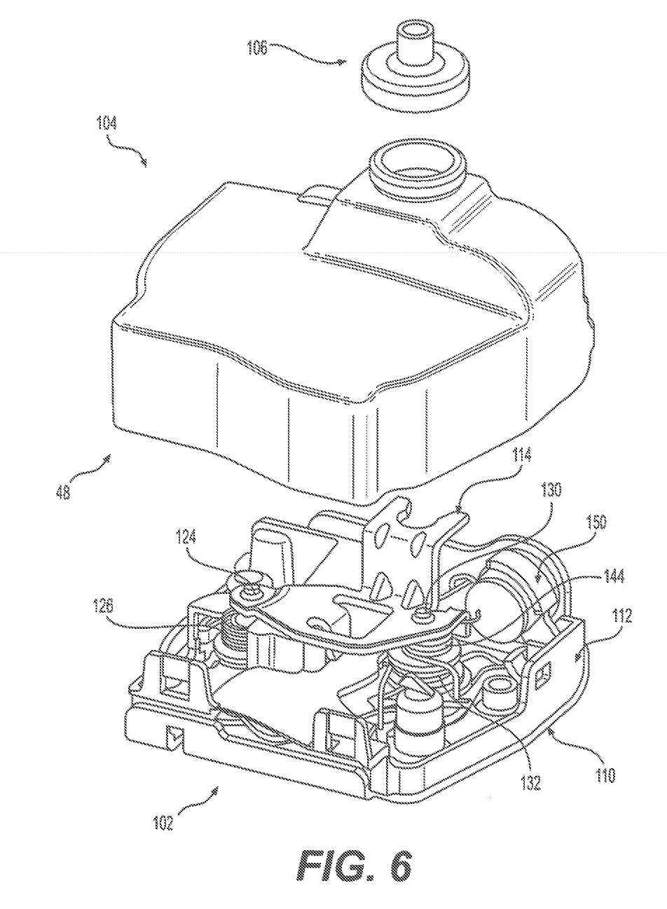

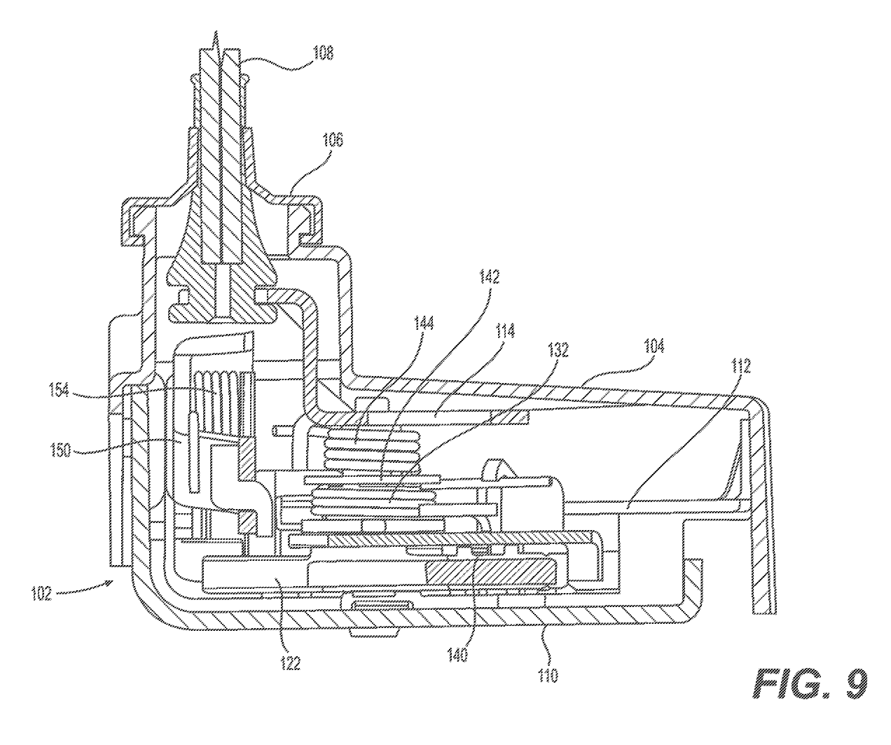

Referring now to FIGS. 4-17, a first non-limiting embodiment of a closure latch assembly will be described to clearly indicate integration of an anti-chucking feature into a latch mechanism for the purpose of eliminating door rattle or “chucking” noise between front door 22 and rear door 28 such as may occur while the motor vehicle is being driven. It is to be understood that the closure latch assembly hereinafter described can be used with rear door 28 and/or front door 22. FIG. 4 illustrates the closure latch assembly of the present disclosure as third closure latch assembly 48 which is mounted to a reinforcement plate 100 which, in turn, is mounted to a portion of front door 22. Closure latch assembly 48 is operable to releaseably latch a striker 178 (FIG. 11) fixed to the edge portion of rear door 28. As best shown in FIG. 6, closure latch assembly 48 generally includes a strength module 102, a latch cover 104, and a seal grommet 106 through which one end of a release cable 108 (FIG. 4) extends.

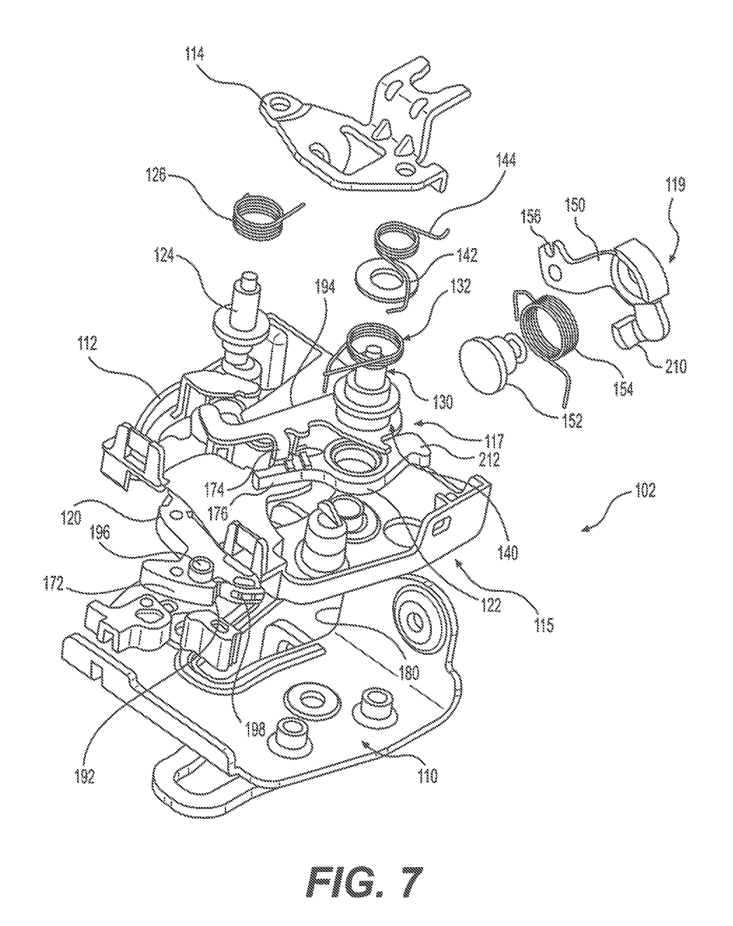

FIG. 7 illustrates an exploded view of strength module 102 to better identify each of its associated components. Strength module 102 generally includes a housing and support structure comprised of a frame plate 110, an intermediate housing 112, and a backplate 114. Disposed between frame plate 110 and intermediate housing 112 is a latch mechanism 115, an anti-chucking mechanism 117, and a latch release mechanism 119. Latch mechanism 115 includes a ratchet 120 and a pawl 122. Ratchet 120 is pivotably supported on frame plate 110 via a ratchet rivet 124 for movement between a striker release position, a secondary striker capture position, a primary striker capture position, and a striker over-travel position. Ratchet 120 is normally biased toward its striker release position via a ratchet spring 126. Pawl 122 is pivotably supported on frame plate 110 via a pawl rivet 130 for movement relative to ratchet 120 between a ratchet holding position and a ratchet releasing position. Pawl 122 is normally biased toward its ratchet holding position via a pawl spring 132. Anti-chucking mechanism 117 generally includes an anti-chuck lever 140, and anti-chuck washer 142, and an anti-chuck lever spring 144. Anti-chuck lever 140 is pivotably supported on pawl rivet 130 for movement between a released position and an engaged position. Anti-chuck lever spring 144 is operable to normally bias anti-chuck lever 140 toward its engaged position. Latch release mechanism 119 is shown to generally include a release lever 150 and a release lever spring 154. Release lever 150 is pivotably mounted on a release lever rivet 152 for movement between a non-actuated position and an actuated position. Release lever spring 154 is configured to normally bias release lever 150 toward its non-actuated position. Release cable 108 is adapted to be interconnected between a first lug segment 156 of release lever 150 and door handle 50 so as to permit release lever 150 to move from its non-actuated position to its actuated position in response to actuation of door handle 50.

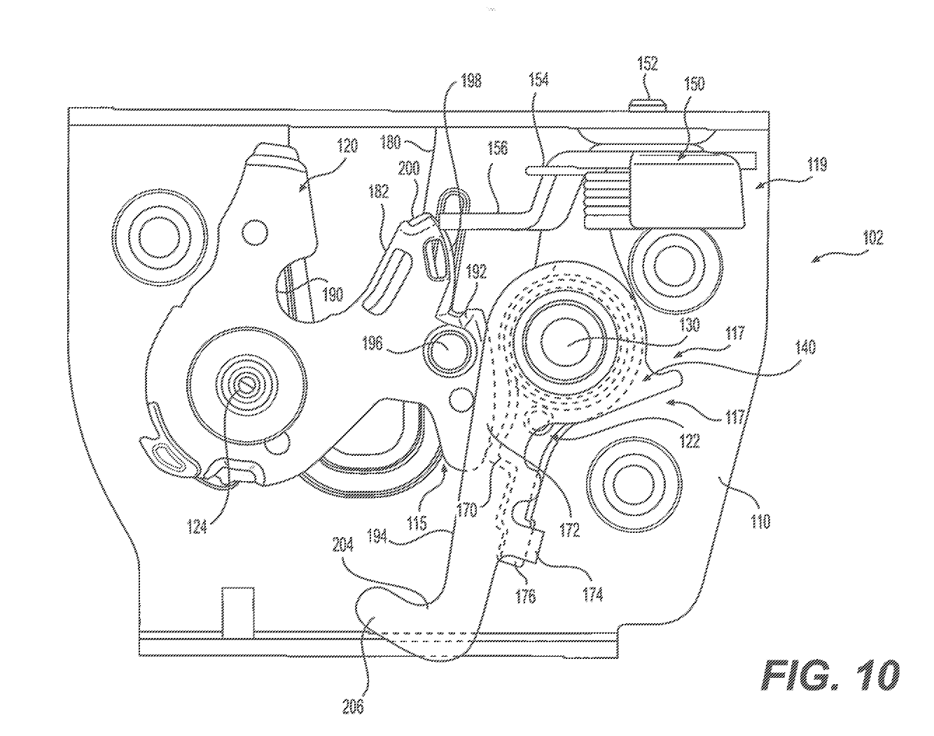

Referring now to FIGS. 10-16, a series of sequential plan views are provided to illustrate operation of closure latch assembly 48. In particular, FIG. 10 shows latch mechanism 115 in an unlatched mode, anti-chucking mechanism 117 in a released mode, and latch release mechanism 119 in a non-actuated mode. Specifically, ratchet 120 is shown in its striker release position (striker 178 mounted to rear door 28 is not shown), pawl 122 is shown held in its ratchet releasing position via engagement of a pawl latch lug 170 with a first ratchet cam surface 172 formed on ratchet 120, and anti-chuck lever 140 is shown held in its released position via engagement of a lever lug segment 174 formed on anti-chuck lever 140 with an elongated leg portion 176 of pawl 122. Thus, FIG. 10 illustrates the arrangement of the components when front door 22 in its open position.

Referring now to FIG. 11, movement of front door 22 from its open position toward its closed position causes striker 178 to enter a fishmouth segment 180 of frame plate 110 and engage a guide channel 182 formed in ratchet 120, thereby forcibly pivoting ratchet 120 in a closing (i.e., clockwise) direction from its striker release position toward its primary striker capture position in opposition to the biasing of ratchet spring 126. Such action causes pawl latch lug 170 to continue to ride along first ratchet cam surface 172 on ratchet 120 so as to continue to hold pawl 122 in its ratchet releasing position. As noted, when pawl 122 is held in its ratchet releasing position, anti-chuck lever 140 is retained in its released position via engagement of lever lug segment 174 with elongated leg portion 176 of pawl 122.

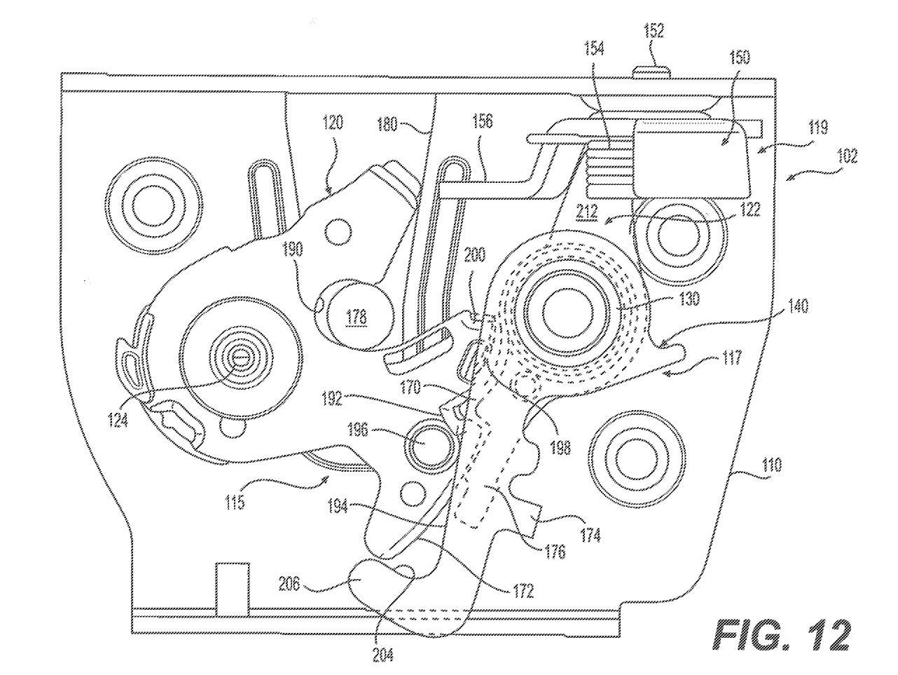

Referring next to FIG. 12, continued rotation of ratchet 120 in the closing direction has now resulted in striker 178 entering a striker retention seat 190 formed in guide channel 182 and also causes pawl latch lug 170 to disengage first ratchet cam surface 172 and move into engagement with a secondary latch shoulder 192 formed on ratchet 120, whereby ratchet 120 is held in its secondary striker capture position by pawl 122 being located in its ratchet holding position. Upon movement of pawl 122 to its ratchet holding position, anti-chuck lever 140 is urged by anti-chuck lever spring 144 in an engaging (i.e., clockwise) direction to move from its released position toward its engaged position until its edge segment 194 engages a stop lug segment 196 extending outwardly from ratchet 120.

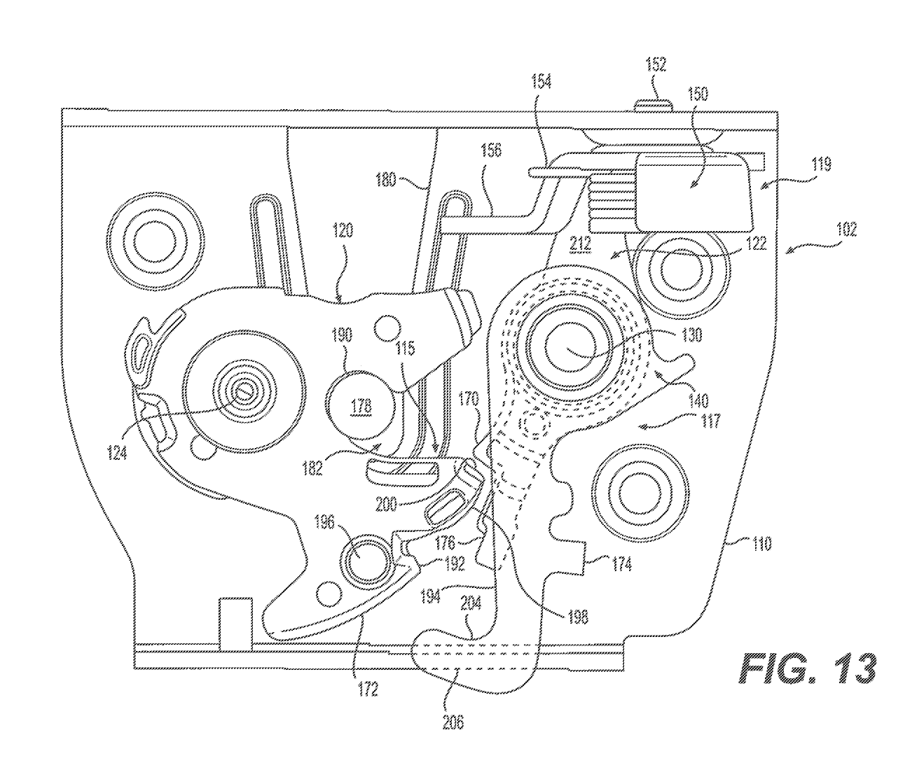

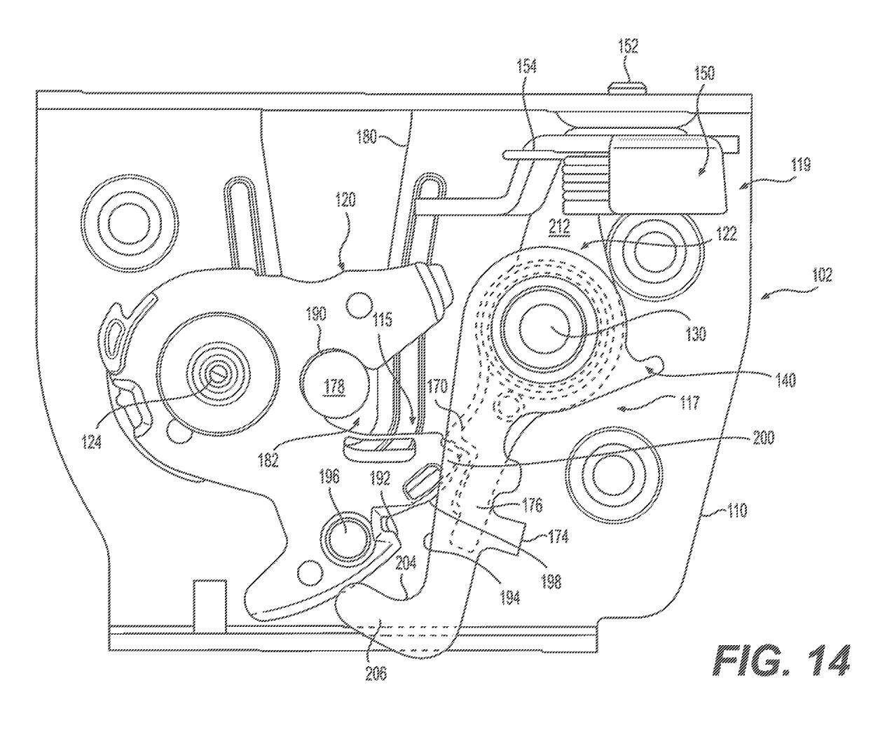

As striker 178 continues to cause ratchet 120 to rotate in the closing direction, pawl latch lug 170 will ride along a second ratchet cam surface 198 formed on ratchet 120 and initially move past a primary latch shoulder 200 formed on ratchet 120 as ratchet 120 moves past its primary striker capture position into its striker over-travel position, as shown in FIG. 13, due to front door 22 being moved to its fully closed (i.e., a “hard slam”) position. This rotation of ratchet 120 to its striker over-travel position permits pawl spring 132 to forcibly move pawl 122 into its ratchet holding position relative to ratchet 120. However, such over-travel of ratchet 120 does not result in latching engagement between pawl latch lug 170 and primary latch shoulder 200. FIG. 14 illustrates subsequent slight rotation of ratchet 120 in a releasing (i.e. counterclockwise) direction caused by ratchet spring 126 which, in turn, causes pawl latch lug 170 to engage primary latch shoulder 200 of ratchet 120, thereby causing pawl 122 in its ratchet holding position to hold ratchet 120 in its primary striker capture position. In this position, latch mechanism 115 is operating in its latched mode.

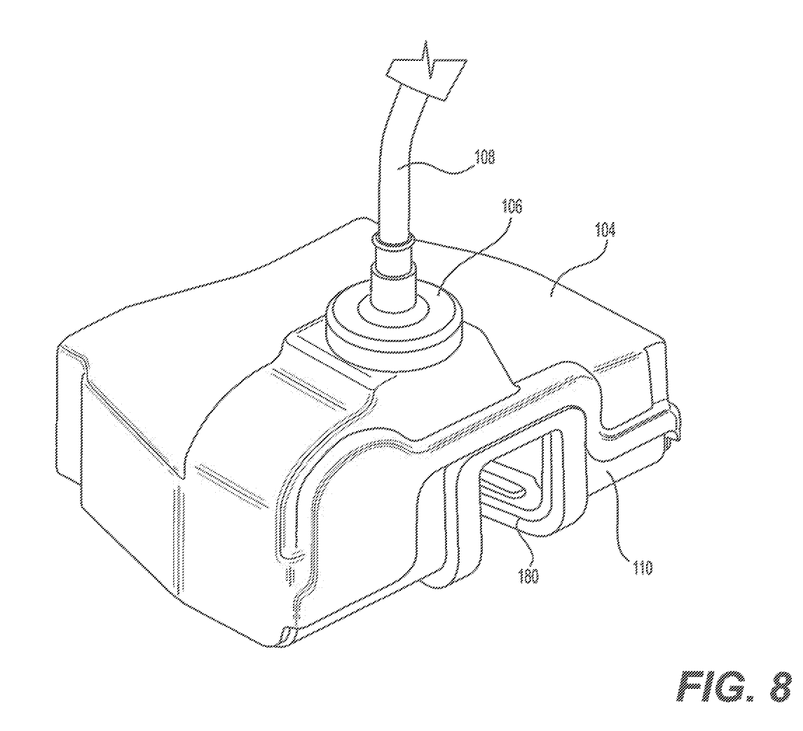

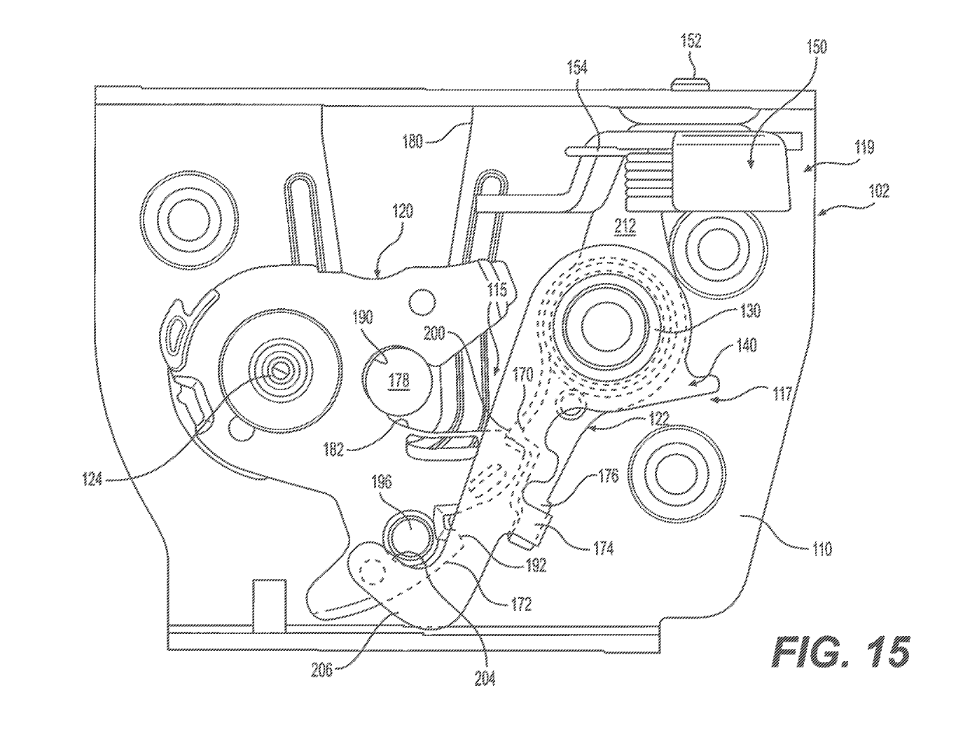

Thereafter, anti-chuck lever spring 144 forcibly pivots anti-chuck lever 140 in the engaging direction until stop lug segment 196 on ratchet 120 is retained against an anti-chuck latch shoulder 204 formed in a bent end segment 206 of anti-chuck lever 140, as best seen in FIG. 15. This engagement between stop lug segment 196 and anti-chuck latch shoulder 204 establishes an engagement interface between ratchet 120 and anti-chuck lever 140. Thus, anti-chuck lever 140 is now located in its engaged position such that anti-chucking mechanism 117 is operating in its engaged mode. To subsequently shift closure latch assembly 48 from its latched mode into its unlatched mode, release cable 108 (see FIG. 8) pulls on release lever 150 for causing release lever 150 to move from its non-actuated position into its actuated position. Such pivotal movement of release lever 150 causes in a tab segment 210 (see FIG. 7) thereon to engage a second leg segment 212 formed on pawl 122 for causing pawl 122 to forcibly move from its ratchet holding position into its ratchet releasing position, thereby permitting ratchet 120 to rotate from its primary striker capture position (FIG. 15) back to its striker release position (FIG. 10). As is understood, a power actuator, such as an electric motor and gearset, could be used to pivot release lever 150 from its non-actuated position into its actuated position to provide a power latch release feature.

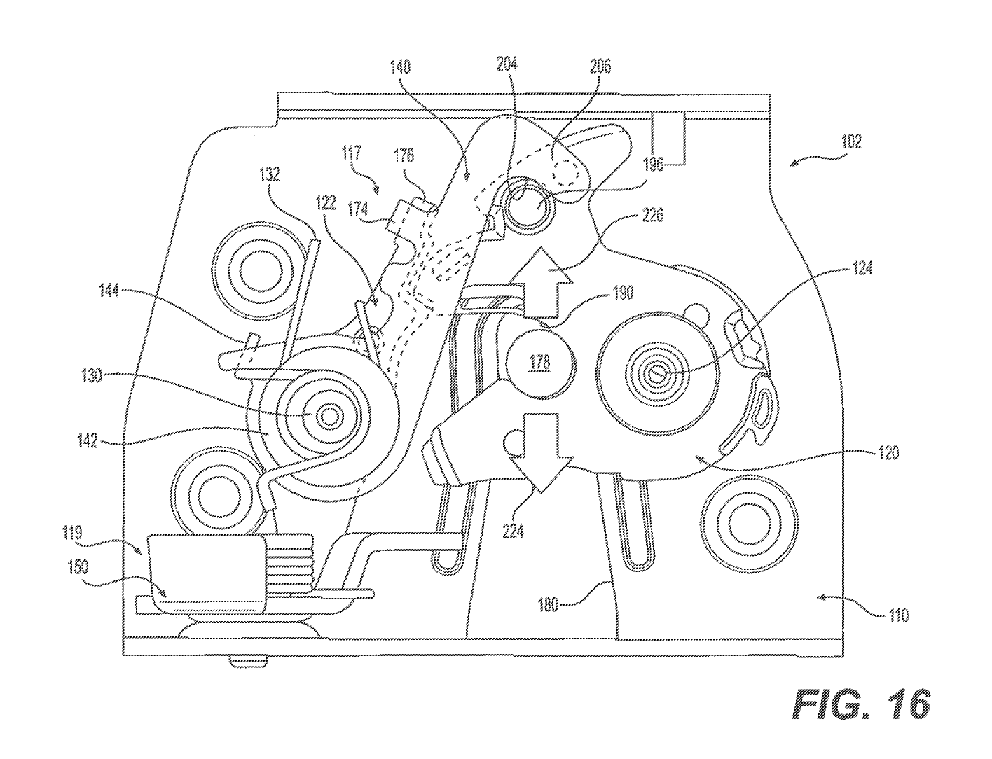

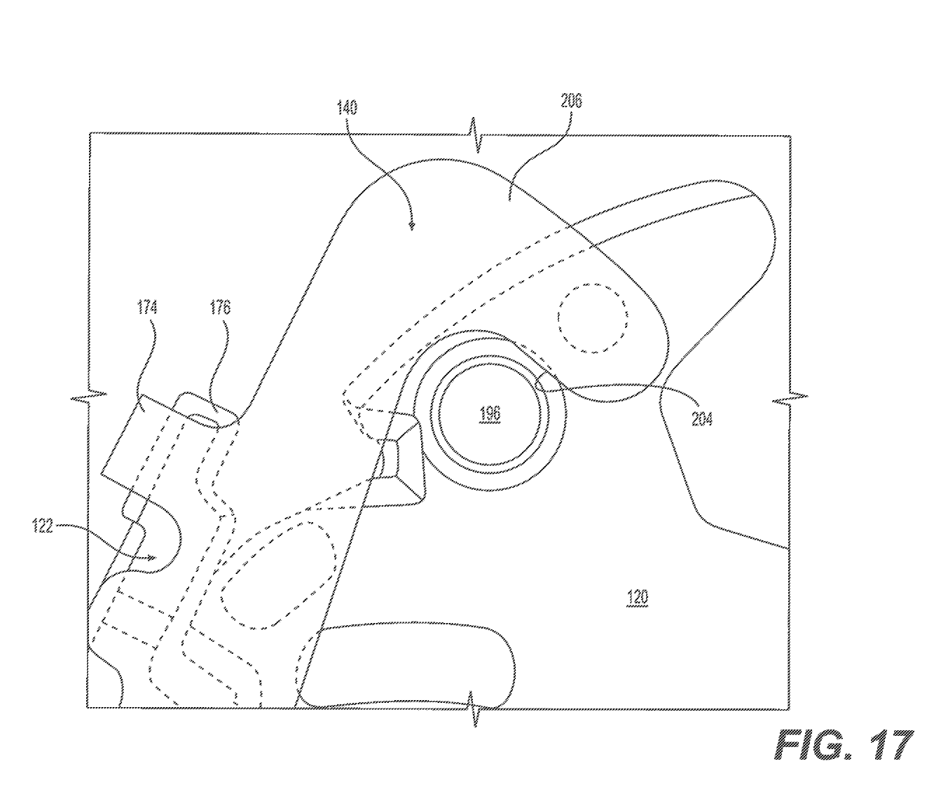

The present disclosure is directed to integrating anti-chucking mechanism 117 with latch mechanism 115 to provide a solution for eliminating chucking movement between striker 178 and ratchet 120 along the pillar-less latching interface between front door 22 and rear door 28 relative to each other and/or relative to vehicle body 10. In particular, pawl 122 and anti-chuck lever 140 work cooperatively when ratchet 120 is located in its primary striker capture position to rigidly retain striker 178 within striker retention seat 190. FIG. 16 illustrates that pawl 122 will resist a striker “push-out” load exerted thereon by ratchet 120, as indicated by arrow 224, in the traditional manner due to engagement of pawl latch lug 170 with primary latch shoulder 200. In addition, anti-chuck lever 140 now resists a striker “push-in” load exerted thereon by ratchet 120, as indicated by arrow 226, due to engagement of stop lug segment 196 with anti-chuck latch shoulder 204. Thus, noise generated due to relative movement between striker 178 and ratchet 120 is eliminated when ratchet 120 is held in its primary striker capture position since over-travel of ratchet 120 in the closing direction is no longer possible. FIG. 17 illustrates that anti-chuck latch shoulder 204 on bent end segment 206 of anti-chuck lever 140 is formed to have a positive backout configuration to provide a “wedging” function to inhibit over-travel of ratchet 120 when held in its primary striker capture position.

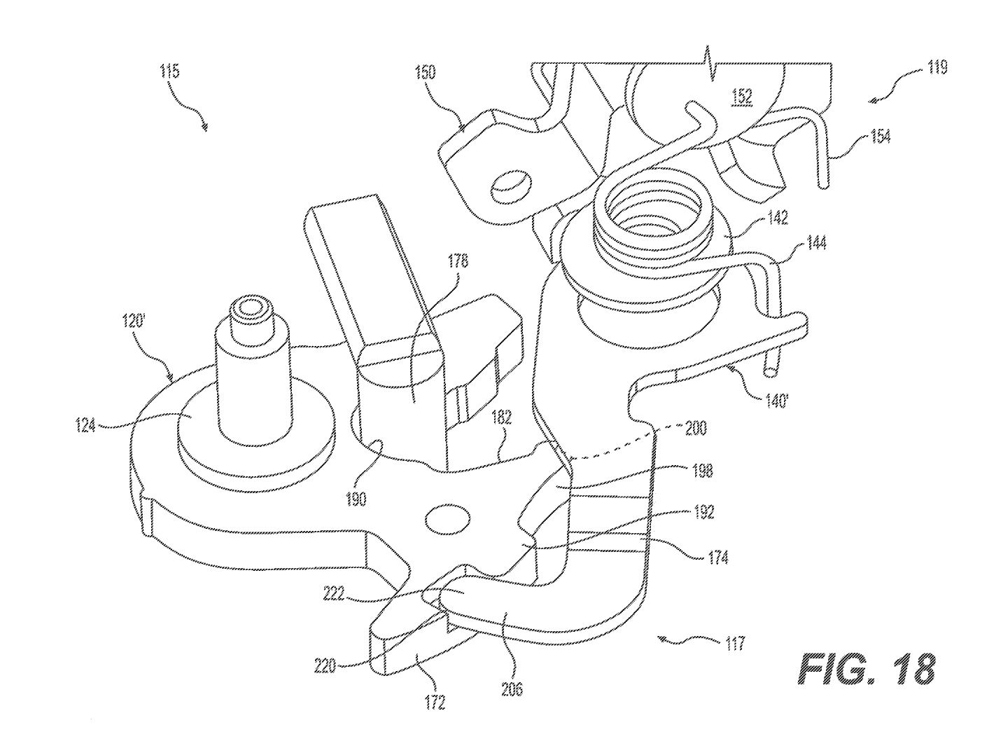

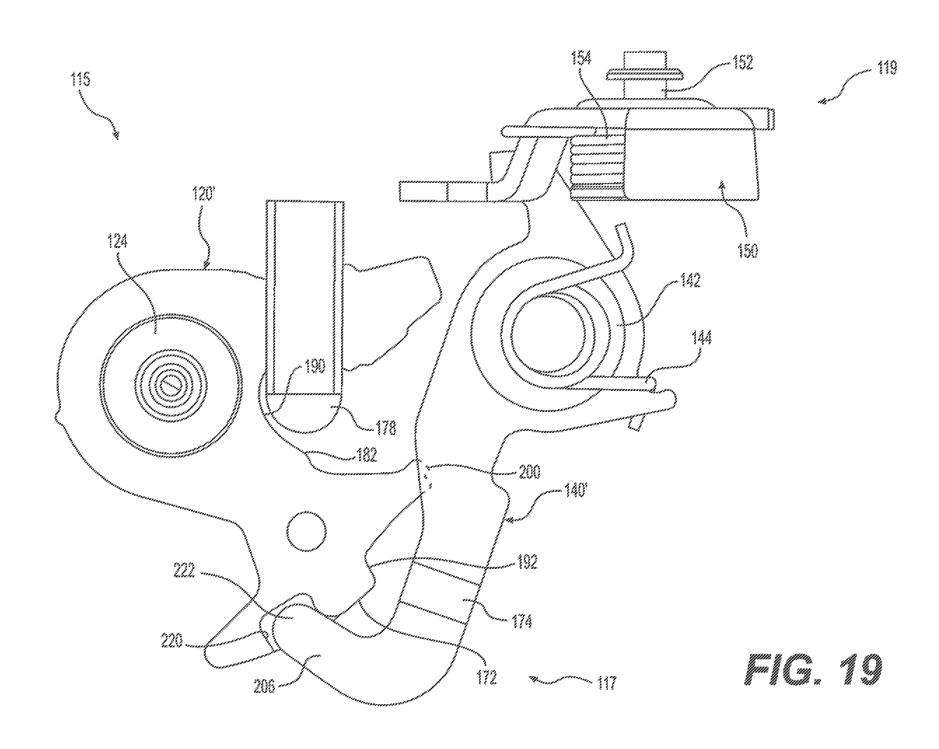

FIGS. 18 and 19 illustrate an alternative version of an engagement interface configuration for providing the anti-chucking function when ratchet 120′ of latch mechanism 115 is held in its primary striker capture position by pawl 122 (see FIG. 14). In particular, a latching notch 220 formed in first ratchet cam surface 172 of ratchet 120′ is sized to receive and releaseably retain lever latch lug 222 formed on bent end segment 206 on anti-chuck lever 140′. With lever latch lug 222 located within latching notch 220, anti-chuck lever 140′ is located in its engaged position and over-travel of ratchet 120′ in the push-in direction is inhibited, thereby providing the anti-chucking feature again directly between ratchet 120′ and anti-chuck lever 140′. As before, movement of pawl 122 from its ratchet holding position to its ratchet releasing position causes corresponding movement of anti-chuck lever 140′ from its engaged position into its released position, thereby releasing lever latch lug 222 of anti-chuck lever 140′ from latching notch 220 in ratchet 120′.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a motor vehicle closure system having a door moveable between open and closed positions, the closure latch assembly comprising:
a latch mechanism having a ratchet moveable between a striker release position, a striker capture position, and a striker over-travel position, a ratchet spring biasing the ratchet toward its striker release position, a pawl moveable between a ratchet holding position for holding the ratchet in its striker capture position and a ratchet releasing position for permitting the ratchet to move to its striker release position, and a pawl spring for biasing the pawl toward its ratchet holding position;
a latch release mechanism operable for moving the pawl from its ratchet holding position into its ratchet releasing position; and
an anti-chucking mechanism having an anti-chuck lever moveable between a released position and an engaged position, and an anti-chuck lever spring for biasing the anti-chuck lever toward its engaged position,
wherein the pawl is operable in its ratchet holding position to inhibit movement of the ratchet in a releasing direction from its striker capture position toward its striker release position, and wherein the anti-chuck lever is operable in its engaged position to engage the ratchet and inhibit movement of the ratchet in a closing direction from its striker capture position toward its striker over-travel position.

2. The closure latch assembly of claim 1, wherein movement of the pawl from its ratchet holding position to its ratchet releasing position in response to actuation of the latch release mechanism causes corresponding movement of the anti-chuck lever from its engaged position to its released position.

3. The closure latch assembly of claim 1, wherein movement of the door from its open position to its closed position causes a striker to engage the ratchet and forcibly move the ratchet in the closing direction from its striker release position to its striker over-travel position, wherein movement of the ratchet into its striker over-travel position permits the pawl to move from its ratchet releasing position into its ratchet holding position, and wherein movement of the pawl to its ratchet holding position permits the anti-chuck lever spring to move the anti-chuck lever from its released position into its engaged position.

4. The closure latch assembly of claim 3, wherein an engagement interface is established between the ratchet and the anti-chuck lever when the anti-chuck lever is located in its engaged position, and wherein the engagement interface inhibits movement of the ratchet in the closing direction from its striker capture position to its striker over-travel position.

5. The closure latch assembly of claim 4, wherein the engagement interface is defined by a stop lug on the ratchet engaging a lever latch shoulder on the anti-chuck lever.

6. The closure latch assembly of claim 5, wherein the lever latch shoulder is configured with a positive backout surface to engage the stop lug on the ratchet.

7. The closure latch assembly of claim 4, wherein the engagement interface is defined by a lever latch lug formed on the anti-chuck lever being retained within a latching notch formed in the ratchet.

8. The closure latch assembly of claim 4, wherein the ratchet spring forcibly moves the ratchet in the releasing direction from its striker over-travel position into its striker capture position such that a pawl latch lug on the pawl engages a latch shoulder on the ratchet for holding the ratchet in its striker capture position when the pawl is located in its ratchet holding position so as to inhibit movement of the ratchet in the releasing direction, wherein the engagement interface between the ratchet and the anti-chuck lever inhibits movement of the ratchet in its closing direction, and wherein engagement of the ratchet with both of the pawl and the anti-chuck lever in its striker capture position provides an anti-chucking feature.

9. The closure latch assembly of claim 8, wherein the anti-chucking feature is configured to retain the striker in a striker retention seat formed in the ratchet and to resist a striker push-out force in the releasing direction and a striker push-in force in the closing direction.

10. The closure latch assembly of claim 8, wherein the striker is fixed to a rear door of a dual-door closure system and the closure latch assembly is fixed to a front door of the dual-door closure system.

11. A closure latch assembly for a motor vehicle having a door moveable between open and closed positions relative to a striker, the closure latch assembly comprising:
a latch mechanism having a ratchet moveable between a striker release position when the door is in its open position, a striker capture position when the door is in its closed position, and a striker over-travel position, and a pawl moveable between a ratchet holding position whereat the pawl holds the ratchet in its striker capture position and a ratchet releasing position whereat the pawl permits the ratchet to move to is striker release position; and
an anti-chucking mechanism having an anti-chuck lever moveable between a released position whereat the anti-chuck lever is disengaged from the ratchet and an engaged position whereat the anti-chuck lever establishes a latched engagement interface with the ratchet,
wherein the pawl is operable in its ratchet holding position to inhibit movement of the ratchet in a ratchet releasing direction from its striker capture position toward its striker release position, and wherein the anti-chuck lever is operable in its engaged position to inhibit movement of the ratchet in a ratchet closing direction from its striker capture position toward its striker over-travel position, whereby the pawl and anti-chuck lever work cooperatively to retain the striker in a striker retention seat formed in the ratchet when the ratchet is located in its striker capture position.

12. The closure latch assembly of claim 11 further comprising a latch release mechanism operable for moving the pawl from its ratchet holding position to its ratchet releasing position for shifting the latch mechanism from a latched mode into an unlatched mode.

13. The closure latch assembly of claim 12, wherein movement of the pawl from its ratchet holding position to its ratchet releasing position in response to actuation of the latch release mechanism causes corresponding movement of the anti-chuck lever from its engaged position to its released position.

14. The closure latch assembly of claim 11, wherein movement of the door from its open position to its closed position causes the striker to engage the ratchet and forcibly move the ratchet in the ratchet closing direction from its striker release position to its striker over-travel position, wherein movement of the ratchet into its striker over-travel position permits the pawl to move from its ratchet releasing position into its ratchet holding position, and wherein movement of the pawl to its ratchet holding position permits the anti-chuck lever to move from its released position into its engaged position.

15. The closure latch assembly of claim 14, wherein the latched engagement interface is established between the ratchet and the anti-chuck lever when the anti-chuck lever is located in its engaged position, and wherein the latched engagement interface inhibits movement of the ratchet in the ratchet closing direction from its striker capture position to its striker over-travel position.

16. The closure latch assembly of claim 15, wherein the latched engagement interface is defined by a stop lug on the ratchet engaging a lever latch shoulder on the anti-chuck lever.

17. The closure latch assembly of claim 16, wherein the lever latch shoulder is configured with a positive backout surface to engage the stop lug on the ratchet.

18. The closure latch assembly of claim 14, wherein the latched engagement interface is defined by a lever latch lug formed on the anti-chuck lever being retained within a latching notch formed in the ratchet.

19. The closure latch assembly of claim 14, wherein a ratchet spring forcibly moves the ratchet in the ratchet releasing direction from its striker over-travel position into its striker capture position such that a pawl latch lug on the pawl engages a latch shoulder on the ratchet for holding the ratchet in its striker capture position when the pawl is located in its ratchet holding position so as to inhibit movement of the ratchet in the ratchet releasing direction, wherein the latched engagement interface between the ratchet and the anti-chuck lever inhibits movement of the ratchet in its ratchet closing direction, and wherein engagement of the ratchet with both of the pawl and the anti-chuck lever in its striker capture position provides an anti-chucking feature.

20. The closure latch assembly of claim 19, wherein the anti-chucking feature is configured to retain the striker in a striker retention seat formed in the ratchet and resist a striker push-out force acting in the ratchet releasing direction and a striker push-in force acting in the ratchet closing direction.
